(19) United States
(12) Patent Application Publication
(10) Pub. No.: US 2004/0019172 A1
(43) Pub. Date: Jan. 29, 2004

(54) Biodegradable, water absorbable resin and its preparation method

(75) Inventors: Kun-Hsiang Yang, Shalu Town (TW); Shih-Ching Yang, Shalu Town (TW); Yuan-Chi Su, Taipei City (TW); Toshio Hara, Sawara-Ku (JP)

Correspondence Address: SCULLY, SCOTT, MURPHY & PRESSER, 400 Grden City Plaza, Garden City, NY, 11530, US

(73) Assignee: Tou-Hsiung Yang, Shalu Town (TW)

(21) Appl. No.: 10/317,573

(22) Filed: Dec. 12, 2002

(30) Foreign Application Priority Data
Jul. 26, 2002 (TW) 091116740

(51) Int. Cl. C08H 1/00; C08G 2/00

(52) U.S. Cl. 527/200; 527/300; 424/443

(57) ABSTRACT

The present invention relates to a method for the production of a biodegradable, water absorbable resin, by directly cross-linking of a culture broth with a cross-linker. The cross-linker contains two or more functional groups in the same molecule which can react with the functional groups in the culture broth. The present invention further relates to a biodegradable, water absorbable resin and its uses.

### FIELD OF THE INVENTION

The present invention relates to a biodegradable, water absorbable resin, and its preparation method and uses.

### BACKGROUND OF THE INVENTION

In recent years, water absorbable resins have been used as not only the materials for paper diapers but also absorbents for liquid or greenification materials in fields such as medical-care, architecture, civil construction, and agriculture, or as fresh-keeping agents for foods.

Conventional methods for preparing water absorbable resins use starches and celluloses cross-linked with acrylnitrile to form acryl-based water absorbable resins. Although such acryl-based resins are low in price, they cannot be decomposed by microorganisms in the soil and thus encounter difficulties in waste treatment. It is believed that to impart water absorbable resins with biodegradability will resolve the problem regarding the waste treatment of resin materials. Therefore, there is a great demand for biodegradable, water absorbable resins in view of the increasing environmental concerns.

In order to achieve the aforementioned object, conventional techniques involve using biodegradable poly-amino acids or polysaccharides as the starting materials for the preparation of biodegradable, water absorbable resins. The methods for the preparation of poly-amino acid based, cross-linked products have been disclosed in prior art such as JP 6-322358, JP 7-224163, JP 7-309943, JP 7-300563, JP 10-298282, and JP 11-343339. For example, JP 6-322358 indicates that a solution of poly-γ-glutamic acid can be cross-linked via an electronic polymerization by radiation, so as to form poly-γ-glutamic acid based cross-linked product. However, the equipments for producing poly-amino acid based, cross-linked products through radiation is very complicated and restricted, such that the production procedure is difficult and inconvenient. JP 11-343339 discloses another method for preparing cross-linked poly-γ-glutamic acid product, comprising isolating a high concentration of poly-γ-glutamic acid from a culture broth, and using the isolated poly-γ-glutamic acid as the starting material for the cross-linking reaction with a polyepoxy compound to obtain a biodegradable, water absorbable resin. Nonetheless, such method not only has the draw back associated with the requirement of a high concentration of poly-γ-glutamic acid but requires relevant operational equipments to improve the solubility of poly-γ-glutamic acid and basic compounds, and also causes the problems of increase in cost and inconvenience in preparation procedure, etc.

Moreover, JP 5-301904 discloses polysaccharides produced from Alcaligenes letus B16. U.S. Pat. No. 4,772,419 also discloses a method for the preparation of cross-linked polysaccharide products.

Obviously, conventional methods for manufacturing cross-linked poly-γ-glutamic acid and polysaccharide products require complicated processing procedures, such as the control and operation of complicated radiation equipments and the separation and refining steps. Surprisingly, the inventors of the present application have found that biodegradable, water absorbable resins with up to 3,000 times water absorption rate can be directly, simply, and successfully prepared by directly cross-linking a culture broth containing a poly-amino acid and/or a polysaccharide with a cross-linker. It is thus unnecessary to separate and refine a high concentration of poly-γ-glutamic acid or polysaccharide from the culture broth.

### BRIEF DESCRIPTION OF THE INVENTION

The present invention relates to a method for the production of a biodegradable, water absorbable resin, by directly cross-linking a culture broth with a cross-linker. The cross-linker contains in the same molecule two or more functional groups which can react with the structural functional groups carboxyl, hydroxyl, aldehyde, carbonyl, sulfone, nitro, and/or amino group in the culture broth.

The present invention further relates to a biodegradable, water absorbable resin prepared by directly cross-linking a culture broth with a cross-linker. The cross-linker comprises a polyepoxy compound with two or more functional groups. The inventive biodegradable, water absorbable resin contains culture components necessary for the growth of microbes and/or metabolites produced by microbes.

### DETAILED DESCRIPTION OF THE INVENTION

In the method according to the present invention of directly cross-linking a culture broth with a cross-linker, the culture broth contains a microbial culture broth selected from the group consisting of poly-γ-glutamic acid, a polysaccharide, and a mixture thereof, and comprises carboxyl, hydroxyl, aldehyde, carbonyl, sulfone, nitro, and/or amino groups. No special limitation on the other components of the culture broth is necessary. All the components that can be used in a culture broth and that are obvious to persons skilled in the art would be suitable for use in the cultural broth of the present invention. In other words, the culture broth used in the present invention can be prepared by any methods known to persons skilled in the art. For example, JP 1-174397 discloses using a culture broth composed of glutamic acid and peptone to grow Bacillus subtilis and Bacillus natto, which can produce poly-γ-glutamic acid.

According to the present invention, the poly-amino acid of the culture broth is selected from the group consisting of poly-γ-glutamic acid, polyaspartic acid, polylysine, and mixtures thereof. In one embodiment of the present invention, poly-γ-glutamic acid, preferably that with a molecular weight of more than 100,000, is used as the poly-amino acid component. Moreover, the polysaccharide of the culture broth is selected from the group consisting of glucose, fructose, rhamnose, and fucose, and mixtures thereof, and a mixture of one or more foregoing polysaccharides with a polycarboxylic acid selected from the group consisting of glucuronic acid, hyaluronic acid, and a mixture thereof.

In the present invention, the species of the cross-linker which contains in the same molecule two or more functional groups that can react with the structural functional groups carboxyl, hydroxyl, aldehyde, carbonyl, sulfone, nitro, and/or amino group in the culture broth, do not require any special limitation. Persons skilled in the art will be able to select a suitable cross-linker to practice the method of the present invention without any difficulty. Basically, it is preferred to use a polyepoxy compound containing two or more epoxy groups in the same molecule, such as diglycidyl ether, as the cross-linker used in the present invention. For example, the diglycidyl ether can be a compound of Formula (I):

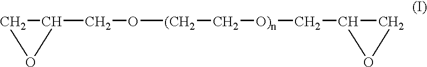

wherein n is from 1 to 22, preferably 1 to 15, and more preferably 1 to 10. In addition, the diglycidyl ether also can be propylene glycol diglycidyl ether or glycerin-1,3-diglycidyl ether.

For conducting the cross-linking reaction of the present invention, the amount of the cross-linker, on the basis of the weight of the culture broth, is normally 0.1 to 10 wt % and preferably 0.25 to 6 wt %. If the amount of the cross-linker is below 0.1 wt %, the water absorbability of the cross-linked product will be adversely affected because of the inadequate cross-linking. However, if the amount of the cross-linker is greater than 10 wt %, the high water absorbability of the cross-linked product will be reduced.

When conducting the aforementioned cross-linking reaction, the cross-linking system is normally maintained at a pH of 3 to 8, and preferably 4.5 to 5.5. Furthermore, the reaction temperature is between 0° C. and 100° C., and preferably 35° C. and 65° C. Generally, it takes a longer time to complete a reaction conducted at a lower temperature and on the contrary, a shorter time for the reaction conducted at a higher temperature. Nonetheless, if the reaction temperature is higher than 100° C., undesired side reactions, such as decomposition, will take place and influence the effectiveness of the cross-linking. In addition, the molar ratio of the functional groups: carboxyl, hydroxyl, aldehyde, carbonyl, sulfone, nitro, and/or amino groups in the culture broth to the epoxy group provided by the cross-linker, is 1:1.

In the method of the present invention, the manner for carrying out the cross-linking reaction does not require any special limitation. For example, glass reactors equipped with stirrer devices or culture containers shaked in an oil or water bath can be utilized to accomplish the cross-linking reaction involved in the present invention. The method of the present invention may further comprise the steps of hydrating the cross-linked culture broth for swelling, removing the un-cross-linked components by filtration, and drying (e.g., lyophilizing) the prepared water absorbable cross-linked product, to obtain the cross-linked product with water absorbability.

Apparently, the method of the present invention can produce highly water absorbable and biodegradable resins more simply and more easily as compared with conventional methods.

The present invention also relates to a biodegradable, water absorbable resin prepared by directly cross-linking a culture broth with a cross-linker. The cross-linker contains two or more functional groups in the same molecule which can react with the functional groups in the culture broth.

The biodegradable, water absorbable resin of the present invention is effective in terms of water absorption and retention, provides more than 3000 times water absorption rate, and can be decomposed by microbes existing in the natural environment so that its waste treatment is safer and simpler. The water absorbable resin of the present invention can be used in fields including, among others, the agricultural and horticultural fields, as desert greenifination materials, soil reconditioning agents, seed coating agents, water-retaining agents for plant cultivation, immobilizing agents for manure of animals, compost adding agents, or water conditioning agents for feces, urine, and sewage sludge; the civil construction field, as water conditioning agents for water treatment sludge, sewage sludge, and river sewer sludge, solidifying agents, modifying agents, coagulants, or soil for reservoir; medical and health-care fields, as absorbents for bloods or body fluids, paper diapers, or de-odorants; and the biotechnology fields, as materials for culturing microbes, plants, or animals, or immobilizing materials for bioreactors.

Moreover, since the biodegradable, water absorbable resin is prepared by directly reacting the culture broth with the cross-linker, it will inherently contain the components of the culture broth necessary for the growth of microbes, such as carbon source, nitrogen source, and minerals, and/or metabolites produced by microbes in the culture broth. In view of this property, the biodegradable, water absorbable resin of the present invention is very suitable for use as an agricultural material for compost aids, seed coating agents, and desert greenification materials.

The biodegradable, water absorbable resin of the present invention can be in any desired shapes. For example, the resin can be granulated into a fixed shape or made into irregular shapes, pellets, plates, etc.

The subject invention will be further described by the following examples. Nonetheless, it should be noted that the working examples are provided for an illustration of the present invention, rather than intended to limit the scope of the present invention.

### EXAMPLE 1

A 300 L culture medium containing 0.5 wt % of yeast extract, 1.5 wt % of peptone, 0.3 wt % of urea, 0.2 wt % of K₂HPO₄, 10 wt % of glutamic acid, and 8 wt % of glucose and having a pH of 6.8 was added to a 600 L fermentor, and Bacillus subtilis was incubated under 37° C. After 72 hours, the culture broth contained 40 g poly-γ-glutamic acid per liter. Each of 10 g of the culture broth was added to 20 ml capped sample bottles into which each of 400 μl of the polyepoxy compounds as listed in Table 1 is introduced. The reaction of the mixtures were conducted with slight agitation at 40° C. for 24 hours.

The reacted liquids were taken out of the 20 ml capped sample bottles and soaked in water at 4° C. for a week to remove any uncross-linked poly-γ-glutamic acid. The cross-linked hydrogel formed after hydration and swelling was then filtered through an 80-mesh metal screen and lyophilized to obtain a cross-linked poly-γ-glutamic acid. The cross-linked product was then tested for its water absorption rate.

For the determination of water absorption rate, the cross-linked product was soaked in an excess amount of distilled water for complete swelling. An 80-mesh metal screen was used to filtrate the excess amount of water to obtain the wetted cross-linked product. The wetted cross-linked product was weighed. The water absorption rate is defined as the ratio of the weight of water absorbed (the difference between the wet and dry weights) to the dry weight. The results of the water absorption rate for this example are shown in Table 1.

TABLE 1

| | reaction time | water absorption |
|---|---|---|
| polyepoxy compound | (hr) | rate |
| ethylene glycol diglycidyl ether (n = 1) | 24 | 3,000 |
| diethylene glycol diglycidyl ether | 36 | 2,900 |
| (n = 2) | | |
| polyethylene glycol diglycidyl ether | 36 | 2,800 |
| (n = 4) | | |
| polyethylene glycol diglycidyl ether | 48 | 2,800 |
| (n = 9) | | |
| polyethylene glycol diglycidyl ether | 48 | 2,500 |
| (n 13) | | |
| polyethylene glycol diglycidyl ether | 48 | 1,300 |
| (n = 22) | | |

### EXAMPLE 2

According to the procedures illustrated in Example 1, ethylene glycol diglycidyl ether was used as the polyepoxy compound. The reaction was conducted for 24 hours, and the pH was varied as those listed in Table 2. The reacted mixtures were further put into an incubation container under a slow agitation to carry out the cross-linking. The results of the water absorption rates of the obtained cross-linked products are listed in Table 2.

TABLE 2

| pH | water absorption rate |
|---|---|
| 4.0 | 2,900 |
| 4.5 | 3,000 |
| 5.0 | 2,900 |
| 5.5 | 2,400 |
| 6.0 | 1,800 |
| 7.0 | 1,700 |

### EXAMPLE 3

According to the procedures illustrated in Example 2, ethylene glycol diglycidyl ether was used as the polyepoxy compound to carry out the cross-linking. The amount of ethylene glycol diglycidyl ether and the reaction time were varied as those listed in Table 3. The results of water absorption rates of the obtained cross-linked products are listed in Table 3.

TABLE 3

| | water absorption rate | | | | |
|---|---|---|---|---|---|
| amount | reaction time (hr) | | | | |
| (μl) | 24 | 48 | 72 | 96 | 120 |
| 250 | 3,220 | 2,700 | _a) | _a) | _a) |
| 400 | 3,000 | 2,120 | 1,980 | 1,426 | 1,221 |
| 550 | 2,370 | 1,660 | 1,450 | 1,540 | 1,070 |
| 700 | 1,450 | 1,530 | 1,400 | 1,260 | 1,330 |

_a)The reaction product is completely liquefied.

### EXAMPLE 4

According to the procedures illustrated in Example 1, ethylene glycol diglycidyl ether was used as the polyepoxy compound. The reaction temperature was set at 40° C. and the reaction time was set for 24 hours. Bacillus subtilis was incubated according to the method described in Example 1, and the incubation time was altered as shown in Table 4. Then, the obtained culture broth was used to conduct cross-linking as illustrated in Example 2. The results of the water absorption rates of the obtained cross-linked products are shown in Table 4.

TABLE 4

| incubation time (hr) | water absorption rate |
|---|---|
| 36 | _b) |
| 48 | 2,550 |
| 60 | 3,210 |
| 72 | 3,000 |
| 84 | 2,860 |
| 96 | 1,580 |

_b): No cross-lined hydrogel is formed.

1. A method for the production of a biodegradable, water absorbable resin comprising directly cross-linking a culture broth with a cross-linker, wherein the cross-linker contains two or more functional groups which can react with the functional groups in the culture broth.

2. The method of claim 1, wherein the culture broth is a microbial culture broth selected from the group consisting of a poly-amino acid, a polysaccharide, and a mixture thereof.

3. The method of claim 2, wherein the poly-amino acid is selected from the group consisting of poly-γ-glutamic acid, polyaspartic acid, polylysine, and mixtures thereof.

4. The method of claim 3, wherein the poly-amino acid is poly-γ-glutamic acid.

5. The method of claim 2, wherein the polysaccharide is selected from the group consisting of glucose, fructose, rhamnose, and fucose, and mixtures thereof, and a mixture of one or more foregoing polysaccharides with a polycarboxylic acid selected from the group consisting of glucuronic acid, hyaluronic acid, and a mixture thereof.

6. The method of claim 1, wherein the functional group in the culture broth comprises carboxyl, hydroxyl, aldehyde, carbonyl, sulfone, nitro, or amino group, or combinations thereof.

7. The method of claim 1, wherein the cross-linker is a polyepoxy compound containing two epoxy groups in the same molecule.

8. The method of claim 7, wherein the polyepoxy compound is diglycidyl ether.

9. The method of claim 8, wherein the diglycidyl ether is a compound of Formula (I): 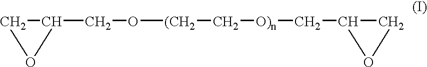
wherein n is between 1 and 22.

10. The method of claim 8, wherein the diglycidyl ether is propylene glycol diglycidyl ether or glycerin-1,3-diglycidyl ether.

11. The method of claim 1, wherein the amount of the cross-linker is 0.1 to 10 wt %, based on the weight of the culture broth.

12. The method of claim 1, wherein the cross-linking is conducted at a temperature from 0° C. to 100° C.

13. The method of claim 1, wherein the cross-linking is conducted at a pH from 3.5 to 8.

14. A biodegradable, water absorbable resin comprising the components of culture broth necessary for the growth of microbes and/or metabolites produced by microbes.

15. The biodegradable, water absorbable resin of claim 14, for use in agricultural and horticultural, civil construction, medical and health-care, or biotechnology materials.

16. The biodegradable, water absorbable resin of claim 15, for use as a compost adding agent, seed coating agent, desert greenification material.

17. A biodegradable, water absorbable resin prepared by directly cross-linking a culture broth with a cross-linker, wherein the cross-linker contains two or more functional groups which can react with the functional groups in the culture broth.

18. The biodegradable, water absorbable resin of claim 17, wherein the culture broth is a microbial culture broth selected from the group consisting of a poly-amino acid, a polysaccharide, and a mixture thereof.

19. The biodegradable, water absorbable resin of claim 18, wherein the poly-amino acid is selected from the group consisting of poly-γ-glutamic acid, polyaspartic acid, polylysine, and mixtures thereof.

20. The biodegradable, water absorbable resin of claim 19, wherein the poly-amino acid is poly-γ-glutamic acid.

21. The biodegradable, water absorbable resin of claim 18, wherein the polysaccharide is selected from the group consisting of glucose, fructose, rhamnose, and fucose, and mixtures thereof, and a mixture of one or more foregoing polysaccharides with a polycarboxylic acid selected from the group consisting of glucuronic acid, hyaluronic acid, and a mixture thereof.

22. The biodegradable, water absorbable resin of claim 17, wherein the functional group in the culture broth comprises carboxyl, hydroxyl, aldehyde, carbonyl, sulfone, nitro, or amino group, or combinations thereof.

23. The biodegradable, water absorbable resin of claim 17, wherein the cross-linker is a polyepoxy compound containing two epoxy groups in the same molecule.

24. The biodegradable, water absorbable resin of claim 23, wherein the polyepoxy compound is diglycidyl ether.

25. The biodegradable, water absorbable resin of claim 24, wherein the diglycidyl ether is a compound of Formula (I): 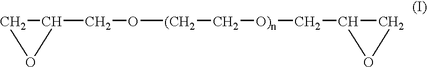
wherein n is between 1 and 22.

26. The biodegradable, water absorbable resin of claim 24, wherein the diglycidyl ether is propylene glycol diglycidyl ether or glycerin-1,3-diglycidyl ether.

27. The biodegradable, water absorbable resin of claim 17, wherein the amount of the cross-linker is 0.1 to 10 wt %, based on the weight of the culture broth.

28. The biodegradable, water absorbable resin of claim 17, wherein the cross-linking is conducted at a temperature from 0° C. to 100° C.

29. The biodegradable, water absorbable resin of claim 17, wherein the cross-linking is conducted at a pH from 3.5 to 8.

30. The biodegradable, water absorbable resin of claim 17, for use in agricultural and horticultural, civil construction, medical and health-care, or biotechnology application.

31. The biodegradable, water absorbable resin of claim 30, for use as a compost aid, seed coating agent, or desert greenification material.
